(19) United States
(12) Patent Application Publication
(10) Pub. No.: US 2024/0355605 A1
(43) Pub. Date: Oct. 24, 2024

(54) PREDICTION OF PRECURSOR CHARGE STATE IN DM-SWATH ANALYSIS

(71) Applicant: DH Technologies Development Pte. Ltd., Singapore (SG)

(72) Inventors: Yves LE BLANC, Newmarket (CA); Gordana IVOSEV, Etobicoke (CA)

(73) Assignee: DH Technologies Development Pte. Ltd., Singapore (SG)

(21) Appl. No.: 18/688,423

(22) PCT Filed: Sep. 2, 2022
(86) PCT No.: PCT/IB2022/058264

§ 371 Date: Mar. 1, 2024

Related U.S. Application Data
(60) Provisional application No. 63/240,569, filed on Sep. 3, 2021.

(51) Int. Cl. H01J 49/00; G01N 27/623; G01N 27/624

(52) U.S. Cl. CPC H01J 49/005; G01N 27/623; G01N 27/624; H01J 49/0036

(57) ABSTRACT

A method for improved mass spectrometry by determining charge state of precursor ions from an analysis of product ions, includes receiving sample ions. A group of precursor ions is selected from the received sample ions based on mobility. A fragmentation device fragments the group of precursor ions to produce a group of product ions. A tandem mass spectrometry analysis is performed on the group of product ions to generate an intensity and mass-to-charge ratio (m/z) of the group of product ions. An ionogram is generated, based on the generated intensities and mass, to charge ratios for the groups of product ions generated for each of the mobility selection. The ionogram includes a first axis representing compensation voltage value and another axis representing intensity. A product ion peak is identified in the ionogram. At least one peak characteristic is identified of the product ion peak. A charge state of a precursor ion that was fragmented to form the product ions represented in the product ion peak is determined based on the at least one peak characteristic of the produce ion peak.

### CROSS-REFERENCE TO RELATED APPLICATION

This application is being filed on Sep. 2, 2022, as a PCT International Patent Application that claims priority to and the benefit of U.S. Provisional Application No. 63/240,569, filed on Sep. 3, 2021, which application is hereby incorporated by reference in its entirety.

### BACKGROUND

As a general overview, mass spectrometry (MS) is an analytical technique for the detection and quantitation of chemical compounds based on the analysis of mass-to-charge (m/z) values of ions formed from those compounds. MS involves ionization of one or more compounds of interest from a sample, producing precursor ions, and mass analysis of the precursor ions. Tandem mass spectrometry or mass spectrometry/mass spectrometry (MS/MS) involves ionization of one or more compounds of interest from a sample, selection of one or more precursor ions of the one or more compounds, fragmentation of the one or more precursor ions into product ions, and mass analysis of the product ions.

Both MS and MS/MS can provide qualitative and quantitative information. The measured precursor or product ion spectrum can be used to identify a molecule of interest. The intensities of precursor ions and product ions can also be used to quantitate the amount of the compound present in a sample.

Mass spectrometry techniques often generate mass spectrum data utilizing a mass-to-charge ratio (m/z) for detected ions. Knowledge of the actual charge or mass of the detected ions, however, is often not directly measurable. As a result, some overlap of detected ions may occur in certain scenarios. For example, a singly charged ion with a mass may appear in the mass spectrum as having the same mass-to-charge ratio as a doubly charged ion with double the mass. This issue may generally be referred to as a peak overlapping problem.

### SUMMARY

In an aspect, the technology relates to a method for improved mass spectrometry by determining charge state of precursor ions from an analysis of product ions, the method including: receiving sample ions; selecting a group of precursor ions from the received sample ions based on mobility; fragmenting, by a fragmentation device, the group of precursor ions to produce a group of product ions; performing a tandem mass spectrometry analysis on the group of product ions to generate an intensity and mass-to-charge ratio (m/z) of the group of product ions; generating an ionogram based on the generated intensities and mass to charge ratios for the groups of product ions generated for each of the mobility selection, wherein the ionogram includes a first axis representing compensation voltage value and another axis representing intensity; identifying a product ion peak in the ionogram; identifying at least one peak characteristic of the product ion peak; and based on the at least one peak characteristic of the product ion peak, determining a charge state of a precursor ion that was fragmented to form the product ions represented in the product ion peak. In an example, the method further includes, based on the determined charge state of the precursor ion, identifying a candidate precursor ion from a plurality of candidate precursor ions. In another example, the method further includes determining the mass of the precursor ion based on the determined charge state for the precursor ion. In yet another example, the at least one peak characteristic includes a peak width. In still another example, the at least one peak characteristic includes a compensation voltage value corresponding to an inferred peak maximum.

In another example of the above aspect, determining the charge state of the precursor ion includes comparing that at least one peak characteristic to a peak characteristic of another peak in the ionogram. In an example, the method further includes filtering, by a mass filter, precursor ions within a precursor ion mass range. In another example, the method further includes filtering, by a mass filter, precursor ions within a precursor ion mass range. In yet another example, the method further includes eluting a solution containing the precursor ions from a liquid-chromatography (LC) device; and for an LC elution period of the precursor ions, applying at least five different compensation voltage values. In still another example, the selecting is by using an ion-mobility device.

In another example of the above aspect, the method further includes setting the ion-mobility device to pass through the sample ions without selection.

In another aspect, the technology relates to a method for improved mass spectrometry by determining charge state of precursor ions from an analysis of product ions, the method including: accessing a plurality of compensation voltages for an ion-mobility device; for each compensation voltage in the plurality of compensation voltages: applying the compensation voltage to the ion-mobility device to select a group of precursor ions; fragmenting, by a fragmentation device, the group of precursor ions to produce a group of product ions; performing a tandem mass spectrometry analysis on the group of product ions to generate an intensity and mass-to-charge ratio (m/z) of the group of product ions; generating an ionogram based on the generated intensities and mass to charge ratios for the groups of product ions generated for each of the compensation voltages, wherein the ionogram includes a first axis representing compensation voltage value and another axis representing intensity; identifying a product ion peak in the ionogram; identifying at least one peak characteristic of the product ion peak; and based on the at least one peak characteristic of the production peak, determining a charge state of a precursor ion that was fragmented to form the product ions represented in the product ion peak. In an example, the method further includes, based on the determined charge state of the precursor ion, identifying a candidate precursor ion from a plurality of candidate precursor ions. In another example, the method further includes determining the mass of the precursor ion based on the determined charge state for the precursor ion. In yet another example, the at least one peak characteristic includes a peak width. In still another example, the at least one peak characteristic includes a compensation voltage value corresponding to an inferred peak maximum.

In another example of the above aspect, determining the charge state of the precursor ion includes comparing that at least one peak characteristic to a peak characteristic of another peak in the ionogram. In an example, the method further includes, filtering, by a mass filter, precursor ions within a precursor ion mass range. In another example, the method further includes, filtering, by a mass filter, precursor ions within a precursor ion mass range. In yet another example, the method further includes eluting a solution containing the precursor ions from a liquid-chromatography (LC) device; and for an LC elution period of the precursor ions, applying at least five different compensation voltage values. In still another example, the method further includes setting the ion-mobility device to pass through the sample ions without selection.

In another aspect, the technology relates to a system for improved mass spectrometry by determining charge state of precursor ions from an analysis of product ions, the system including: an ion-mobility device configured to separate precursor ions based on a compensation voltage; a tandem mass spectrometer that receives the separated precursor ions from the ion-mobility device and includes a fragmentation device to fragment precursor ions and a mass analyzer to mass analyze resulting product ions; a processor in communication with the ion-mobility device and the tandem mass spectrometer; and memory storing instructions that, when executed by the processor, cause the system to perform a set of operations including: for each compensation voltage in the plurality of compensation voltages: applying, by the ion-mobility device, the compensation voltage to select a group of precursor ions; fragmenting, by the fragmentation device, the group of precursor ions to produce a group of product ions; and performing, by the tandem mass spectrometer, on the group of product ions to generate an intensity and mass-to-charge ratio (m/z) of the group of product ions; generating an ionogram based on the generated intensities and mass to charge ratios for the groups of product ions generated for each of the compensation voltages, wherein the ionogram includes a first axis representing compensation voltage value and another axis representing intensity; identifying a product ion peak in the ionogram; identifying at least one peak characteristic of the product ion peak; and based on the at least one peak characteristic of the product ion peak, determining a charge state of a precursor ion that was fragmented to form the product ions forming the product ions represented in the product ion peak. In an example, the ion-mobility device includes a differential mobility spectrometry (DMS) device includes two parallel planar electrodes. In another example, the differential mobility device includes a high-field asymmetric-waveform ion-mobility spectrometry (FAIMS) mobility device includes two curved parallel electrodes.

In another aspect, the technology relates to a method for improved mass spectrometry by determining charge state of precursor ions from an analysis of product ions, the method including: accessing a plurality of compensation voltages for an ion-mobility device; for each compensation voltage in the plurality of compensation voltages: applying the compensation voltage to the ion-mobility device to select a group of precursor ions; fragmenting, by a fragmentation device, the group of precursor ions to produce a group of product ions; performing a tandem mass spectrometry analysis on the group of product ions to generate an intensity and mass-to-charge ratio (m/z) of the group of product ions; generating an ionogram based on the generated intensities and mass to charge ratios for the groups of product ions generated for each of the compensation voltages, wherein the ionogram includes a first axis representing compensation voltage value and another axis representing intensity; identifying a first product ion peak in the ionogram and a second ion peak in the ionogram, wherein the first product ion peak is formed from product ions having a first mass-to-charge ratio and the second product ion peak is formed from product ions having a second mass-to-charge ratio; identifying at least one peak characteristic of the first product ion peak; identifying at least one peak characteristic of the second product ion peak; and based on the at least one peak characteristic of the first product ion peak, determining a charge state of a precursor ion that was fragmented to form the first product ions represented in the first product ion peak. In an example, the determined charge state is a determination as to whether the precursor ion is singly charged or multiply charged. In another example, determining the charge state includes comparing the at least one peak characteristic of the first product ion peak to the at least one peak characteristic of the second product ion peak.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 is a schematic diagram of a system for controlling a DMS device and a tandem mass spectrometer to sequentially select separate groups of precursor ions with different differential mobilities and to mass filter, fragment, and mass analyze the resulting product ions of each group, in accordance with various embodiments.

FIG. 2 is a schematic diagram of the DMS device of FIG. 1.

FIG. 3 is an exemplary flowchart showing the steps of an exemplary acquisition during each retention time cycle of a DM-SWATH LC-MS/MS experiment designed to validate identified peptides, in accordance with various embodiments.

FIG. 4 is a schematic illustration of a DM-SWATH workflow.

FIG. 5 is a diagram illustrating an ionogram obtained at a specific SV for a peptide mixture.

FIG. 6 is a diagram illustrating the relationship between CoV peak width and peptide charge states.

FIG. 7A is a diagram illustrating a MS spectra capturing a peptide of two different charge states.

FIG. 7B is an ionogram for the two precursor ions with different charge state.

FIG. 7C is an ionogram of precursor ions originated from the precursor ions of FIG. 7B.

FIG. 8 is a flowchart illustrating a method for improved mass spectrometry by determining charge state of precursor ions from an analysis of product ions.

### DETAILED DESCRIPTION

In bottom-up analysis, the protein mixture is digested with trypsin, which produces a complex mixture of tryptic peptide that are analyzed by LC-MS and MSMS. This is typically done with automated collection of MSMS information using data dependent analysis (DDA) where precursor ions are selected in real-time to generate production scan. Due to the complexity of the samples, MSMS information is collected sporadically over the elution portion of the precursor ion, and consequently, cannot be used for quantitation, but only for identification with data base searching. The MS signal can be used for quantitation, but depending on the sample complexity, there is a high risk of interference, especially for low level peptides.

On the other hand, data independent acquisition technology (e.g., marketed by AB Sciex under the trade name SWATH), relies on the combination of wide isolation windows (20-50 amu) and high resolution MS/MS analysis to provide a digitized map of all fragment ions for all precursor ions generated at the source. From these data set, it is possible to extract selective and quantitative information for all species that are separated from the liquid chromatography (LC). With the hope of further enhancing sample throughput, there is a desire to significantly relax LC separation and rely on alternate separation technique to maintain the selectivity. To achieve this, ion mobility and differential mobility have been suggested as techniques to be lined to SWATH analysis. An example of this SWATH technology is described in PCT Publication No. WO2012/035412, the disclosure of which is hereby incorporated by reference herein in its entirety.

In conventional sequential windowed acquisition tandem mass spectrometry (SWATH-MS), each product ion spectrum is acquired sequentially with a sequential increase in the precursor ion mass selection window across the precursor ion mass range.

In order to accommodate the duty cycle requirements associated with LC analysis, a combination of SWATH acquisition that relies predominantly on the selectivity that differential mobility spectrometry (DMS) could offer is introduced. In the DM-SWATH acquisition, each product ion spectrum is acquired sequentially with a sequential increase in differential mobility (DM).

As briefly discussed above, DM-SWATH acquisition is introduced to accommodate the duty cycle requirements associated with LC analysis. By relying on the single SWATH window in the DM-SWATH acquisition, the duty cycle of the experiment is significantly reduced (e.g., 20 times in one example). However, one of the drawback of DM-SWATH acquisition is that the compensation voltage information of the precursor ion is not captured in the process. Accordingly, when LC analysis of complex mixture is performed, grouping precursor ions and product ions based on retention time alone could be very challenging.

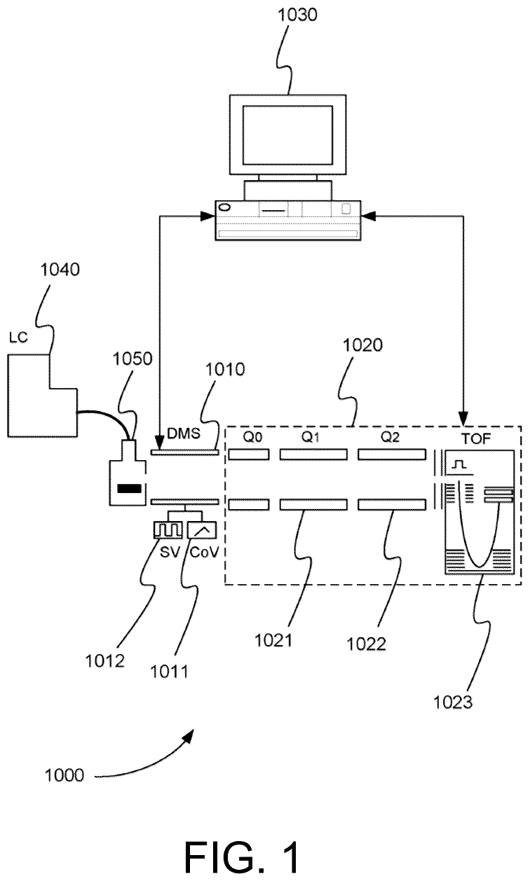

In accordance some aspects of the disclosure, in DM-SWATH acquisition, due to the wide precursor window, the likelihood of capturing two or more peptides of different charge states at the same compensation voltage is high. By inferring the charge state of the precursor ion based on the relationship between compensation voltage peak width and peptide charge states, a short list of potential precursor ion candidates that generated the observed MS/MS data can be produced. As a result, from a massive list of precursor ions and charge state observed, only those that have the appropriate compensation voltage peak width would be associated with detected and grouped product ions. This information could then be used to increase the speed of database search by reducing the combination of precursor-ion-and-product-ion groups and increase the confidence of the result as well. Details of the above-mentioned description in the current paragraph will be described below with reference to FIGS. 1-8

FIG. 1 is a schematic diagram of a system 1000 for controlling a DMS device and a tandem mass spectrometer to sequentially select separate groups of precursor ions with different differential mobilities and to mass filter, fragment, and mass analyze the resulting product ions of each group, in accordance with various embodiments. In the example of FIG. 1, the system 1000 includes a DMS device 1010, a tandem mass spectrometer 1020, and a processor 1030.

The DMS device 1010 is configured to separate precursor ions based on a compensation voltage. Compensation voltage may be abbreviated in examples as “CoV” or “CV”. For clarity in the context of this specification, CoV is primarily utilized, but both abbreviations are encompassed in the technologies described herein. An exemplary DMS device is the SelexION™ device produced by SCIEX.

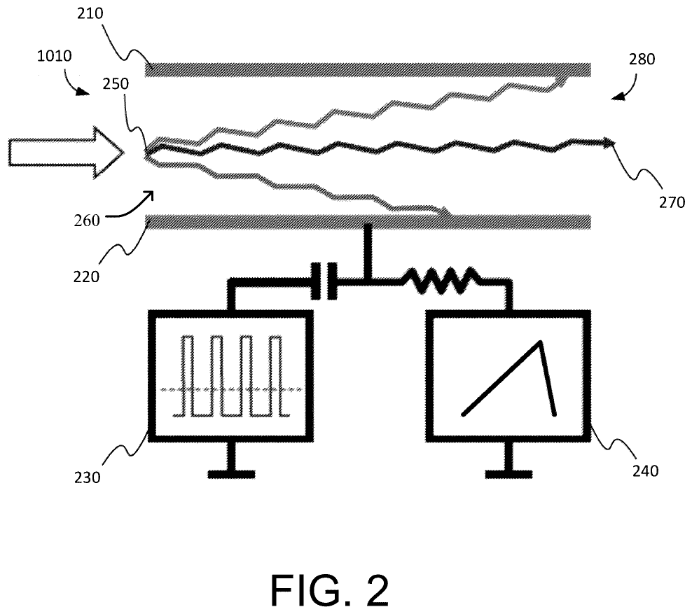

FIG. 2 is a schematic diagram of the DMS device 1010 of FIG. 1. The DMS device 1010 includes two parallel flat plates, plate 210 and plate 220, which serve as electrodes. A radio frequency (RF) voltage source 230 applies an RF separation voltage. Separation voltage may be abbreviated in examples as “SV” or “EV”. For clarity in the context of this specification, SV is primarily utilized, but both abbreviations are encompassed in the technologies described herein. The SV is applied across the plate 210 and the plate 220, and a direct current (DC) voltage source 240 applies a DC CoV across the plate 210 and plate 220. Ions 250 enter the DMS device 1010 in a transport gas at an opening 260. The separation of the ions 250 in the DMS device 1010 is based upon differences in their migration rates under high versus low electric fields.

Unlike traditional ion mobility, the ions 250 are not separated in time as they traverse the device. Instead, the ions 250 are separated in trajectory based on the difference in their mobility between the high field and low field portions of applied RF voltage source 230. The high field is applied between the plate 210 and the plate 220 for a short period of time, and then a low field is applied in the opposite direction for a longer period of time. Any difference between the low-field and high-field mobility of an ion of a compound of interest causes it to migrate towards one of the plates. The ion is steered back towards the center-line of the device by the application of a second voltage offset, known as the CoV of the DC voltage source 240, a compound-specific parameter that can be used to selectively filter out all other ions. Rapid switching of the CoV allows the user to concurrently monitor many different compounds. The ions 270 selected by the combination of SV and CoV, leave the DMS device 1010 through the other opening 280 to the remainder of the mass spectrometer (not shown). The DMS device 1010 is located between an ion source (not shown) and the remainder of the mass spectrometer, for example.

In general, the DMS device 1010 has two modes of operation. In the first mode, the DMS device 1010 is on, SV and CoV voltages are applied, and the ions 250 are separated. This is typically referred to as the enabled mode.

In the second mode of operation, the DMS device 1010 is off, the SV is set to zero and ions 250 are simply transported from the opening 260 to the opening 280. This is typically referred to as the disabled or transparent mode of the DMS device 1010.

In the enabled mode, the DMS device 1010 can acquire MSMS data for a single precursor ion in 25 milliseconds (ms), for example, including pause time. In the transparent mode, the delay through the DMS device 1010 is negligible.

Referring back to FIG. 1, it should be noted that the DMS device 1010 is one example of various ion-mobility devices. In other implementations, the DMS device 1010 may be replaced by a high-field asymmetric-waveform ion-mobility spectrometry (FAIMS) mobility device. Unlike the DMS device 1010 which has two parallel planar electrodes, a FAIMS mobility device includes two curved parallel electrodes. In the context of a FAIMS mobility device, the compensation voltage is typically denoted as “CV” instead of “CoV”, whereas the separation voltage SV is replaced with a dispersion voltage. For simplicity, the description below will be based on the DMS device 1010, but it should be noted that the disclosure below also applies to the mobility devices.

Referring to FIG. 1, the tandem mass spectrometer 1020 receives the separated precursor ions from the DMS device 1010. The tandem mass spectrometer 1020 includes a mass filter 1021 and a fragmentation device 1022 to filter and fragment precursor ions and a mass analyzer 1023 to mass analyze resulting product ions. The mass filter 1021 is shown as quadrupole in the example of FIG. 1. However, the mass filter 1021 can be any type of mass filter. The fragmentation device 1022 is shown as quadrupole collision cell (CID) in the example of FIG. 1. However, the fragmentation device 1022 can be any type of fragmentation device that can support electron capture dissociation (ECD) or photofragmentation (e.g. ultraviolet photo-dissociation-UVPD), as example. The mass analyzer 1023 is shown as time-of-flight (TOF) mass analyzer in the example of FIG. 1. However, the mass analyzer 1023 can be any type of mass analyzer. A mass analyzer of a tandem mass spectrometer can include, but is not limited to, for example a time-of-flight (TOF) device, a quadrupole, an ion trap, a linear ion trap, an orbitrap, a magnetic four-sector mass analyzer, a hybrid quadrupole time-of-flight (Q-TOF) mass analyzer, an electrostatic ion trap, or a Fourier transform mass analyzer.

The processor 1030 is in communication with the DMS device 1010 and tandem mass spectrometer 1020. The processor 1030 can be, but is not limited to, the system of FIG. 1, a computer, microprocessor, microcontroller, or any device capable of sending and receiving control signals and data to and from the DMS device 1010 and the tandem mass spectrometer 1020 and other devices.

The processor 1030 receives signals corresponding to a plurality of compensation voltages for the DMS device 1010 and a precursor ion mass range for the mass filter 1021. The plurality of CoVs and the precursor ion mass range may be received from a user through a user interface (not shown) or from a memory (not shown). The plurality of CoVs and the precursor ion mass range may be defined as part of a standard acquisition method or as part of a customized experiment.

In a preferred embodiment, the plurality of CoVs are a plurality of increasing CoVs. In an alternative embodiment, the plurality of CoVs are a plurality of decreasing CoVs. In another alternative embodiment, the plurality of CoVs are a plurality of randomly varying CoVs.

For each CoV of the plurality of CoVs, the processor 1030 performs a number of steps. In a first step, the processor 1030 applies the CoV to DMS device 1010 to select a group of precursor ions. The processor 1030 applies the CoV to the DMS device 1010 by controlling the CoV voltage supply 1011, for example.

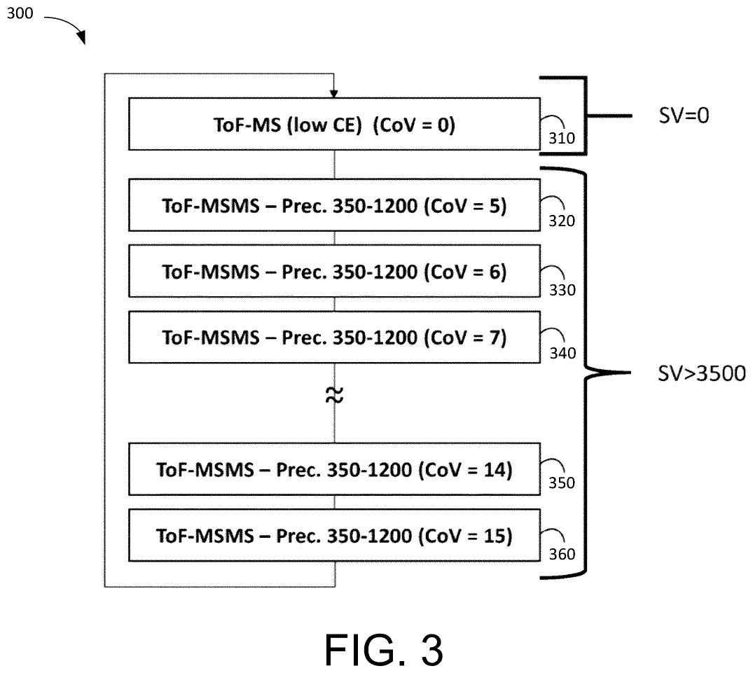

As briefly mentioned above, DM-SWATH acquisition is used to accommodate the duty cycle requirements associated with LC analysis. FIG. 3 is an exemplary flowchart 300 showing the steps of an exemplary acquisition during each retention time cycle of a DM-SWATH LC-MS/MS experiment designed to validate identified peptides, in accordance with various embodiments. In general, unlike conventional SWATH acquisition which relies on multiple precursor window for MS/MS analysis, DM-SWATH acquisition relies on a single precursor window (>500 amu) that is repeated across multiple CoV values when MS/MS data is acquired. Similar to SWATH analysis, the DM-SWATH workflow collects a high resolution MS scan where the DMS is operated in the transparent mode. When compared to a conventional SWATH acquisition that would need to be repeated at multiple CoV, the DM-SWATH workflow offers significant gains in terms of duty cycle, thus making it applicable to ultra-performance liquid chromatography (UPLC) applications.

At operation 310, a low collision energy (CE) time-of-flight (TOF) mass spectrometry (MS) analysis is performed as in conventional SWATH LC-MS/MS. The DMS device 1010 is switched off by setting the compensation voltage (CoV) and the RF separation voltage (SV) to zero. A precursor ion mass analysis is performed for the wide precursor ion mass range, typically from m/z 350 to 1500, but not limited to that range. From this precursor ion mass analysis, a precursor ion mass spectrum is produced for all ions generated at the ion source. From all of the precursor ion mass spectra produced for the plurality of cycles of the liquid chromatography (LC) experiment, an extracted ion chromatogram (XIC) is calculated for each precursor ion found.

At operation 320, the DMS device 1010 is turned on using a CoV of 5 V and an SV of 3500 V (or E/N^{~} 100 Td). For the precursor ions selected by the DMS device 1010, a TOF-MS/MS analysis is performed for the entire wide precursor ion mass range of 350 to 1200 m/z. As a result, precursor ions selected by the DMS device 1010 and in the wide precursor ion mass range of 350 to 1200 m/z are selected and fragmented. The resulting product ions are then mass analyzed. From this product ion mass analysis a product ion mass spectrum is produced.

At operation 330, the CoV of the DMS device 1010 is essentially stepped to a higher value of 6 V. The SV of the DMS device 1010 is kept constant at 3500 V (or E/N^{~} 100 Td). Again, for the precursor ions selected by the DMS device 1010 at this CoV, precursor ions are further selected from the wide precursor ion mass range of 350to 1200 m/z and fragmented, the resulting product ions are mass analyzed, and a product ion mass spectrum is produced.

At operation 340, the CoV of the DMS device 1010 is again stepped or increased to a higher value of 7 V. The SV of the DMS device 1010 is kept constant at 3500 V (or E/N^{~} 100 Td). Also, again for the precursor ions selected by the DMS device 1010 at this CoV, precursor ions are further selected from the wide precursor ion mass range of 350 to 1200 m/z and fragmented, the resulting product ions are mass analyzed, and a product ion mass spectrum is produced.

The process of stepping the CoV value of the DMS device 1010 continues for an additional eight steps. The total number of steps is eleven in this particular example, but there is no limit to the number of steps that may be performed as part of the described technologies. Processes that utilize three steps, five steps, eight steps, ten steps, twelve steps, or other numbers of steps are contemplated. The total number of steps may be an odd number or an even number, and the number may be modified as required or desired for any particular implementation. Returning to FIG. 3, the last two steps are shown as operations 350 and 360. The SV value of the DMS device, the precursor ion mass selection window of the tandem mass spectrometer, and the CE of the tandem mass spectrometer are all held constant for all eleven steps.

From each of the eleven steps in each cycle, a product ion spectrum is obtained. As a result, eleven product ion spectra are obtained for each cycle. From all of the product ion mass spectra produced for each CoV value of the DMS device for the plurality of cycles of the LC experiment, an XIC is calculated for each product ion found.

In the example of FIG. 9, the CoV of the DMS device 1010 starts at a low value and is stepped or increased to a higher value in each step. In an alternative embodiment, the CoV of the DMS device 1010 starts at a high value and is stepped or decreased to a lower value in each step. In another alternative embodiment, a predetermined list CoV values for the DMS device may have varying levels of intensity. For example, the CoV values on the list may increase and decrease multiple times. In this case, the CoV of the DMS device 1010 starts at an initial value and is stepped or moved to the next value of the list in each step. In other words, the CoV values on the list do not necessarily have to uniformly increase or decrease but can vary randomly. Although the sequential variation in CoV values can vary randomly, the values used have to be known and repeatable.

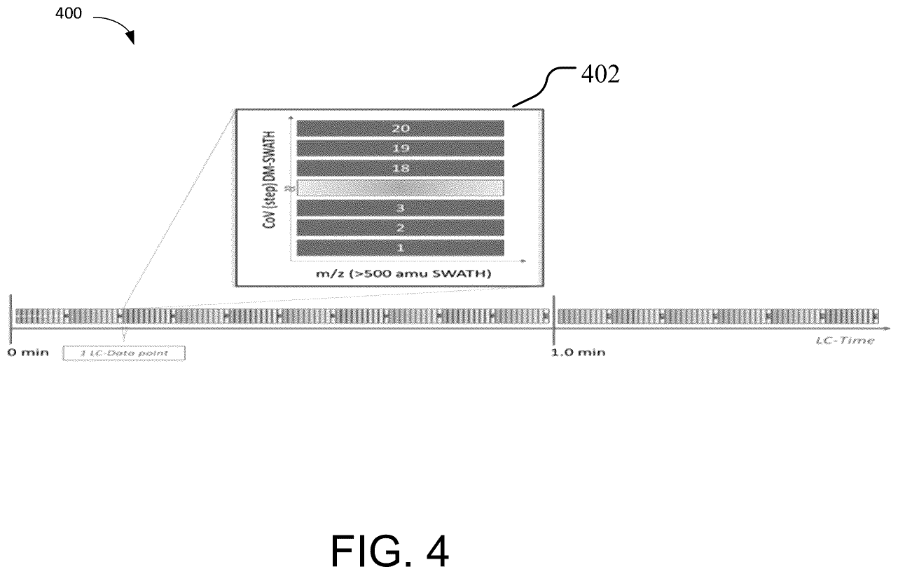

FIG. 4 is a schematic illustration 400 of a DM-SWATH workflow. In the example of FIG. 4, each LC data point 402 includes a single wider window (e.g., >500 amu in this example) rather multiple narrower windows (e.g., 50 amu) like in the regular SWATH acquisition with a DMS device 1010. By relying on the single SWATH window in the DM-SWATH acquisition, the duty cycle of the experiment is significantly reduced (e.g., 20 times in one example). In other words, the selectivity of the DMS device 1010 is relied on and the precursor selection window is relaxed to ensure a rapid duty cycle that would be compatible with LC separation. In doing so, information about the precursor that more likely generated the observed fragmentation can only be linked to LC retention time behavior/profile as no DMS information is collected for the intact precursor (unless a second dedicated experiment is acquired).

As in conventional SWATH LC-MS/MS, peptides represented by precursor ions are, for example, validated by finding their corresponding product ions. Corresponding product ions of the narrower 50 m/z precursor ion mass ranges are found by matching the retention times of their XIC peaks to the retention times of the XIC peaks of the precursor ions. However, as mentioned above, the CoV value of the precursor ion is not captured in the process. Therefore, it is desirable to have methods and systems that would allow users to infer the most likely precursor ion that generated fragment ions at a given CoV.

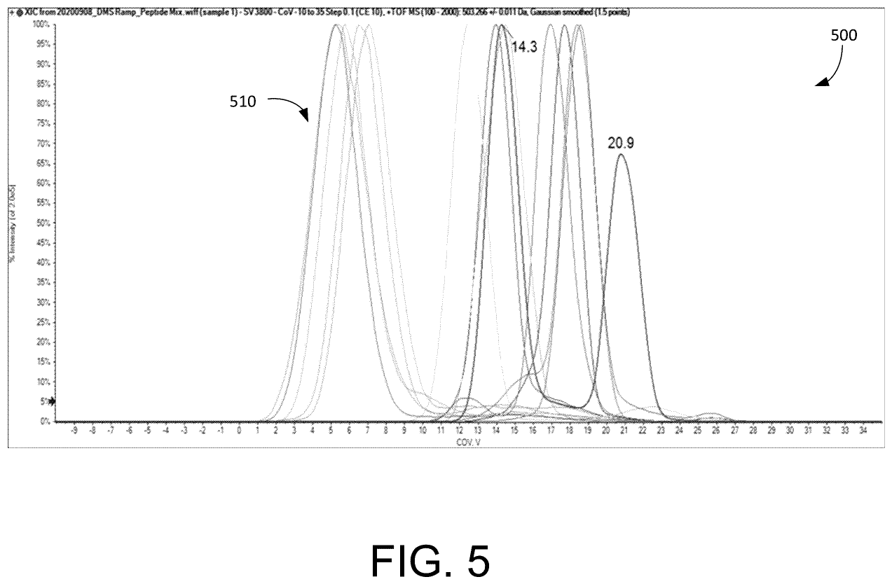

FIG. 5 is a diagram illustrating an ionogram 500 obtained at a specific SV for a peptide mixture. When CoV is ramped over a certain voltage range, the signal generated for a given precursor ion will produce a Gaussian distribution centered around the optimum CoV voltage for transmission of that precursor ion. In some cases, the CoV profile can be the combination of multiple Gaussian curves, suggesting the presence of multiple analyte with same precursor mass. In the example of FIG. 5, the ionogram 500 is obtained at SV=3800. Singly charged peptides have CoV optima ranging from about 5 volts to 8 volts (a cluster of peaks 510 as shown in FIG. 5). Multiply charged (e.g., doubly charged, triply charged, and the like) peptides have CoV optima with other ranges.

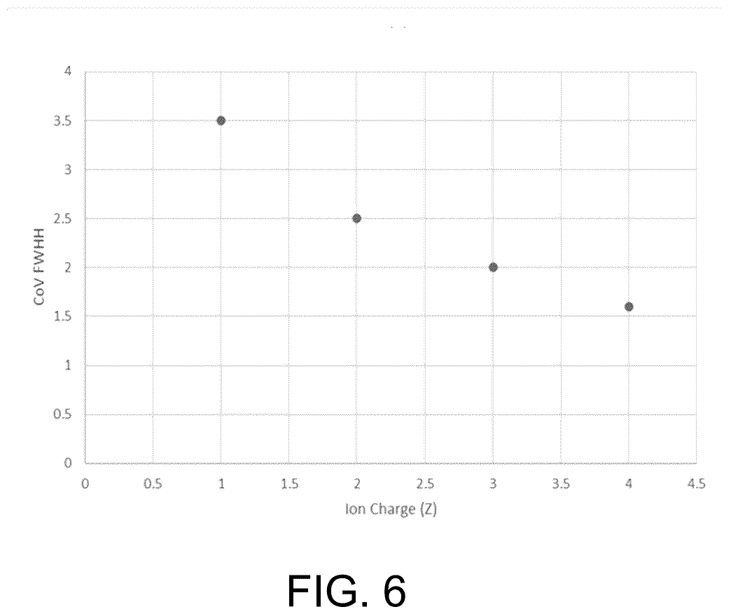

FIG. 6 is a diagram illustrating the relationship between CoV peak width and peptide charge states. In the example of FIG. 6, CoV peak width is used as one example of peak characteristics of the product ion peak. Specifically, the CoV peak width is a full width at half maximum (FWHM), which is the difference between the two CoV values at which the intensity is equal to half of its maximum value. It should be noted that other peak characteristics may be used to serve the same purpose.

As shown in FIG. 6, CoV FWHM decreases as the charge state of the peptide increases. When the ion charge is one, the CoV FWHM is 3.5V; when the ion charge is two, the CoV FWHM is 2.5V; when the ion charge is three, the CoV FWHM is 2V; when the ion charge is four, the CoV FWHM is about 1.6V. Therefore, by monitoring the CoV FWHM, or generally the peak characteristics of the product ion peaks, detected in DM-SWATH acquisition, one can infer the charge state of the precursor ion that more likely generated the MS/MS data. This information could then be used to determine the most probable candidate precursor ions for additional downstream data processing from DM-SWATH acquisition. Conventionally, when LC analysis of complex mixture is performed, grouping precursor ions and product ions based on retention time alone can be a daunting task. Since the CoV of the original precursor ion is unknown, a direct correlation in the CoV dimension is not possible. In contrast, based on the relationship between CoV peak width and peptide charge states, as shown in the example of FIG. 6, it is now possible to infer the charge state of the original precursor ions, thus narrowing down the list of potential precursor ion candidates associated with the MS/MS data collected.

In DM-SWATH acquisition, due to the wide precursor window (e.g., >500 amu as shown in FIG. 4), the likelihood of capturing two or more peptides of different charge states at the same CoV is high. By inferring the charge state of the precursor ion based on the relationship between CoV peak width and peptide charge states, a short list of potential precursor ion candidates that generated the observed MS/MS data can be produced. As a result, from a massive list of precursor ions and charge state observed, only those that have the appropriate CoV peak width would be associated with detected and grouped product ions. This information could then be used to increase the speed of database search by reducing the combination of precursor-ion-and-product-ion groups and increase the confidence of the result as well.

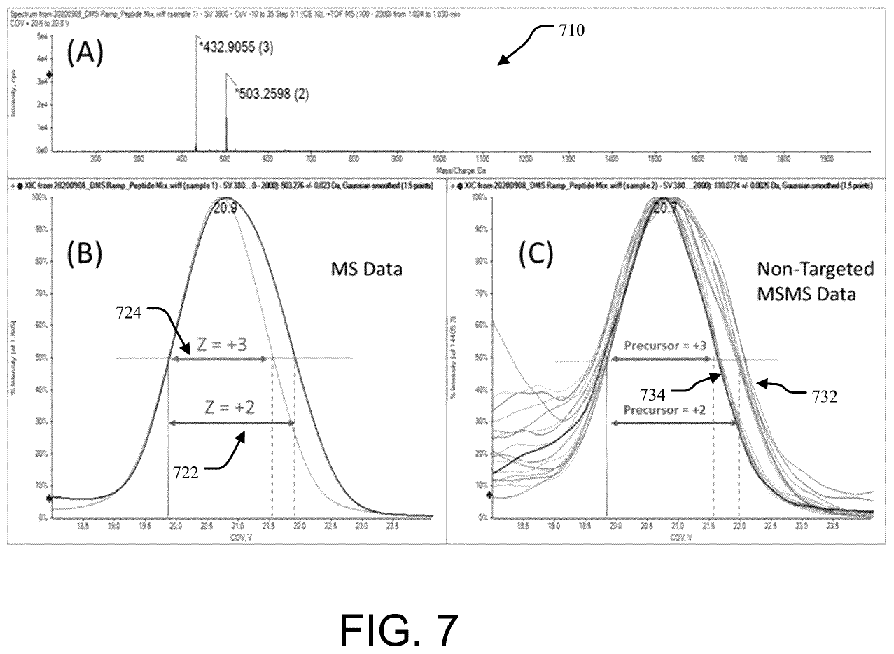

FIG. 7A is a diagram illustrating a MS spectra 710 capturing a peptide of two different charge states. FIG. 7B is an ionogram for the two precursor ions with different charge state. FIG. 7C is an ionogram of precursor ions originated from the precursor ions of FIG. 7B.

In the example of FIG. 7A, the same peptide has two charge states: (1) a charge state of three associated with the m/z of 432.9055; and (2) a charge state of two with the m/z of 503.2598. As mentioned above, they are captured at the same CoV because of the wide precursor window. As shown in FIG. 7B, the doubly-charged precursor ion has a larger CoV FWHM 722 than the CoV FWHM 724 of the triply-charged precursor ion. Using this information, it is possible to associate appropriate precursor ion candidates with the product ions. In the example of FIG. 7C, the ionogram cluster 732 is associated with precursor ions having a charge state of two (corresponding to m/z of 503.2598 in FIG. 7A), whereas the ionogram cluster 734 is associated with precursor ions having a charge state of three (corresponding to m/z of 432.9055 in FIG. 7A).

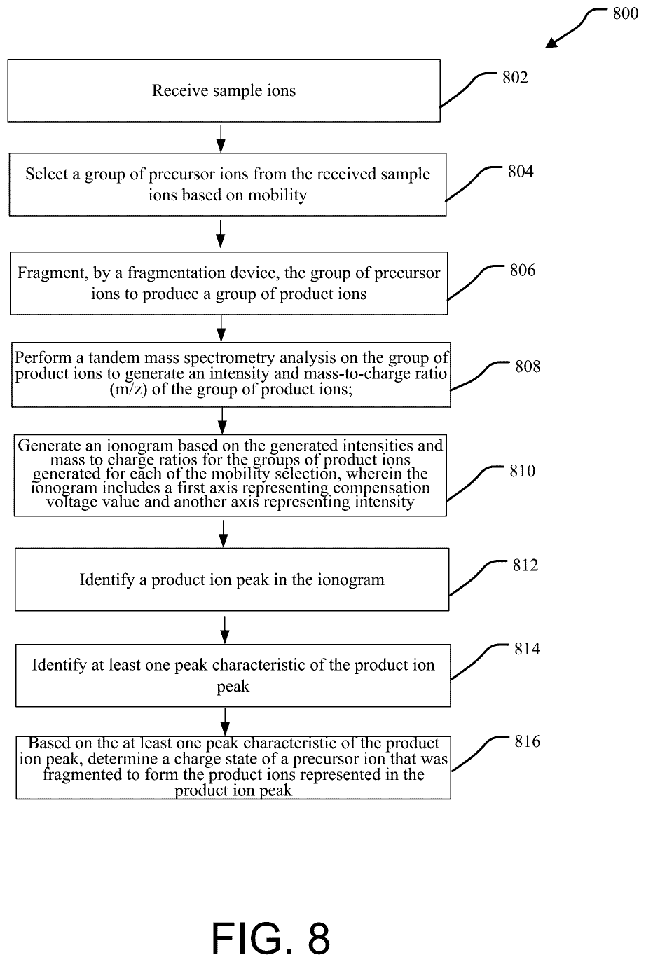

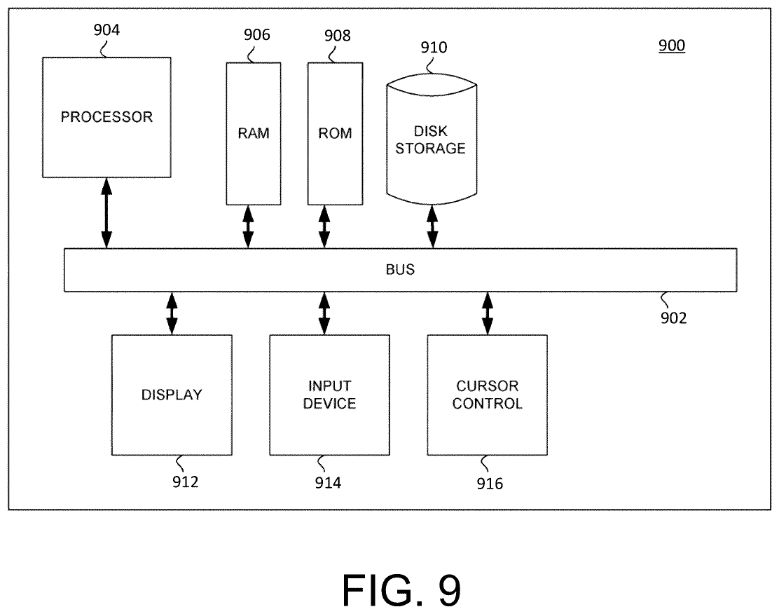

FIG. 8 is a flowchart illustrating a method 800 for improved mass spectrometry by determining charge state of precursor ions from an analysis of product ions. The method 800 include operations 802-816. It should be noted that the method 800 may include other operations as well.

At operation 802, sample ions are received. At operation 804, a group of precursor ions are selected from the received sample ions based on mobility. In one implementation, the group of precursor ions are selected by using a ion-mobility device. In one example, the ion-mobility device is a DMS device. In another example, the ion-mobility device is a FAIMS mobility device. In another example, the ion mobility device is operated in transmission mode to capture the precursor ions and in separation mode to capture the production ions originating from multiple precursors simultaneously.

At operation 806, the group of precursor ions are fragmented, by a fragmentation device, to produce a group of product ions. At operation 808, a tandem mass spectrometry analysis is performed on the group of product ions to generate an intensity and mass-to-charge ratio (m/z) of the group of product ions.

At operation 810, an ionogram is generated based on the generated intensities and mass to charge ratios for the groups of product ions generated for each of the mobility selection. In one implementation, the ionogram includes a first axis representing compensation voltage value and another axis representing intensity.

At operation 812, a product ion peak in the ionogram is identified. Various peak identification techniques may be employed. In some implementations, an inferred peak is identified after operation 812. At operation 814, at least one peak characteristic of the product ion peak is identified. In one implementation, the at least one peak characteristic includes a peak width.

At operation 816, based on the at least one peak characteristic of the product ion peak, a charge state of a precursor ion that was fragmented to form the product ions represented in the product ion peak is determined.

FIG. 9 is a block diagram that illustrates a computer system 900, upon which embodiments of the present teachings may be implemented. Computer system 900 includes a bus 902 or other communication mechanism for communicating information, and a processor 904 coupled with bus 902 for processing information. Computer system 900 also includes a memory 906, which can be a random access memory (RAM) or other dynamic storage device, coupled to bus 902 for storing instructions to be executed by processor 904. Memory 906 also may be used for storing temporary variables or other intermediate information during execution of instructions to be executed by processor 904. Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (CRT) or liquid crystal display (LCD), for displaying information to a computer user. An input device 914, including alphanumeric and other keys, is coupled to bus 902 for communicating information and command selections to processor 904. Another type of user input device is cursor control 916, such as a mouse, a trackball or cursor direction keys for communicating direction information and command selections to processor 904 and for controlling cursor movement on display 912. This input device typically has two degrees of freedom in two axes, a first axis (i.e., x) and a second axis (i.e., y), that allows the device to specify positions in a plane.

The computer system 900 can perform the present teachings Consistent with certain implementations of the present teachings, results are provided by computer system 900 in response to processor 904 executing one or more sequences of one or more instructions contained in memory 906. Such instructions may be read into memory 906 from another computer-readable medium, such as storage device 910. Execution of the sequences of instructions contained in memory 906 causes processor 904 to perform the process described herein. Alternatively, hard-wired circuitry may be used in place of or in combination with software instructions to implement the present teachings. Thus implementations of the present teachings are not limited to any specific combination of hardware circuitry and software.

In various embodiments, the computer system 900 can be connected to one or more other computer systems, like the computer system 900, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example.

The term “computer-readable medium” as used herein refers to any media that participates in providing instructions to processor 904 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 902.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 904 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 902 can receive the data carried in the infra-red signal and place the data on bus 902. Bus 902 carries the data to memory 906, from which processor 904 retrieves and executes the instructions. The instructions received by memory 906 may optionally be stored on storage device 910 either before or after execution by processor 904.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method for improved mass spectrometry by determining charge state of precursor ions from an analysis of product ions, the method comprising:
receiving sample ions;
selecting a group of precursor ions from the received sample ions based on mobility;
fragmenting, by a fragmentation device, the group of precursor ions to produce a group of product ions;
performing a tandem mass spectrometry analysis on the group of product ions to generate an intensity and mass-to-charge ratio (m/z) of the group of product ions;
generating an ionogram based on the generated intensities and mass to charge ratios for the groups of product ions generated for each of the mobility selection, wherein the ionogram includes a first axis representing compensation voltage value and another axis representing intensity;
identifying a product ion peak in the ionogram;
identifying at least one peak characteristic of the product ion peak; and
based on the at least one peak characteristic of the product ion peak, determining a charge state of a precursor ion that was fragmented to form the product ions represented in the product ion peak.

2. The method of claim 1, further comprising, based on the determined charge state of the precursor ion, identifying a candidate precursor ion from a plurality of candidate precursor ions.

3. The method of claim 1, further comprising, determining the mass of the precursor ion based on the determined charge state for the precursor ion.

4. The method of claim 1, wherein the at least one peak characteristic includes a peak width.

5. The method of claim 1, wherein the at least one peak characteristic includes a compensation voltage value corresponding to an inferred peak maximum.

6. The method of claim 1, wherein determining the charge state of the precursor ion includes comparing that at least one peak characteristic to a peak characteristic of another peak in the ionogram.

7. The method of claim 1, further comprising, filtering, by a mass filter, precursor ions within a precursor ion mass range.

8. The method of claim 1, further comprising, filtering, by a mass filter, precursor ions within a precursor ion mass range.

9. (canceled)

10. The method of claim 1, wherein the selecting is by using an ion-mobility device.

11. The method of claim 10, further comprising:
setting the ion-mobility device to pass through the sample ions without selection.

12. A method for improved mass spectrometry by determining charge state of precursor ions from an analysis of product ions, the method comprising:
accessing a plurality of compensation voltages for an ion-mobility device;
for each compensation voltage in the plurality of compensation voltages:
applying the compensation voltage to the ion-mobility device to select a group of precursor ions;
fragmenting, by a fragmentation device, the group of precursor ions to produce a group of product ions;
performing a tandem mass spectrometry analysis on the group of product ions to generate an intensity and mass-to-charge ratio (m/z) of the group of product ions;
generating an ionogram based on the generated intensities and mass to charge ratios for the groups of product ions generated for each of the compensation voltages, wherein the ionogram includes a first axis representing compensation voltage value and another axis representing intensity;
identifying a product ion peak in the ionogram;
identifying at least one peak characteristic of the product ion peak; and
based on the at least one peak characteristic of the product ion peak, determining a charge state of a precursor ion that was fragmented to form the product ions represented in the product ion peak.

13. The method of claim 12, further comprising, based on the determined charge state of the precursor ion, identifying a candidate precursor ion from a plurality of candidate precursor ions.

14. The method of claim 12, further comprising, determining the mass of the precursor ion based on the determined charge state for the precursor ion.

15. The method of claim 12, wherein the at least one peak characteristic includes a peak width.

16. The method of claim 12, wherein the at least one peak characteristic includes a compensation voltage value corresponding to an inferred peak maximum.

17. The method of claim 12, wherein determining the charge state of the precursor ion includes comparing that at least one peak characteristic to a peak characteristic of another peak in the ionogram.

18. The method of claim 12, further comprising, filtering, by a mass filter, precursor ions within a precursor ion mass range.

19. (canceled)

20. The method of claim 12, further comprising:
eluting a solution containing the precursor ions from a liquid-chromatography (LC) device; and
for an LC elution period of the precursor ions, applying at least five different compensation voltage values.

21. (canceled)

22. A system for improved mass spectrometry by determining charge state of precursor ions from an analysis of product ions, the system comprising:
an ion-mobility device configured to separate precursor ions based on a compensation voltage;
a tandem mass spectrometer that receives the separated precursor ions from the ion-mobility device and includes a fragmentation device to fragment precursor ions and a mass analyzer to mass analyze resulting product ions;
a processor in communication with the ion-mobility device and the tandem mass spectrometer; and
memory storing instructions that, when executed by the processor, cause the system to perform a set of operations including:
for each compensation voltage in the plurality of compensation voltages:
applying, by the ion-mobility device, the compensation voltage to select a group of precursor ions;
fragmenting, by the fragmentation device, the group of precursor ions to produce a group of product ions; and
performing, by the tandem mass spectrometer, on the group of product ions to generate an intensity and mass-to-charge ratio (m/z) of the group of product ions;
generating an ionogram based on the generated intensities and mass to charge ratios for the groups of product ions generated for each of the compensation voltages, wherein the ionogram includes a first axis representing compensation voltage value and another axis representing intensity;
identifying a product ion peak in the ionogram;
identifying at least one peak characteristic of the product ion peak; and
based on the at least one peak characteristic of the product ion peak, determining a charge state of a precursor ion that was fragmented to form the product ions forming the product ions represented in the product ion peak.

23. The system of claim 22, wherein the ion-mobility device comprises a differential mobility spectrometry (DMS) device comprising two parallel planar electrodes.

24-27. (canceled)
